(19) United States
(12) Patent Application Publication
(10) Pub. No.: US 2007/0026121 A1
(43) Pub. Date: Feb. 1, 2007

(54) Sweetening compositions

(76) Inventors: Shane Riley Benedict, Hatfield, PA (US); Steven J. Catani, Athens, GA (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/391,032

(22) Filed: Mar. 28, 2006

Related U.S. Application Data
(60) Provisional application No. 60/673,134, filed on Apr. 20, 2005.

(51) Int. Cl. A23L 1/236

(52) U.S. Cl. 426/548

(57) ABSTRACT

A sweetening composition having a crystalline matrix that contains a first material that includes nutritive sweeteners, low calorie sweeteners, sugar polymers, sugar alcohols and combinations thereof and is in intimate contact with a second material that includes at least one high intensity sweetener. The sweetening composition having a size that allows a crystal to be selected by hand, with a low caloric content with about 1 gram of the sweetening composition providing at least 4 grams of sucrose equivalent sweetness.

### CROSS REFERENCE TO RELATED APPLICATIONS

This application claims the benefit of U.S. Provisional Application 60/673,134, filed on Apr. 20, 2005, which is incorporated by reference herein in its entirety.

### FIELD OF THE INVENTION

The present invention is in the field of sweetening compositions. In particular, it is directed to crystalline forms of irregular sizes and shapes containing a bulking material and a high intensity sweetener.

### BACKGROUND OF THE INVENTION

Consumers add many flavors to foods they consume, customizing those foods to their personal tastes. One of the most commonly added flavors is sweet. Sweeteners are added to beverages, such as, coffees and teas, on cereals, on fruits, as toppings on baked goods and in many other ways.

Sweeteners are typically extracted from plants that produce them in various quantities and for various purposes. For example, sucrose, a sweetener in wide spread use, is produced by sugar cane and in sugar beet roots. Well-known processes are used to extract and purify sucrose from these and other plants. Other sweeteners, such as, dextrose (glucose) and fructose, can also be produced from various grain plants by well-known processes. These sweeteners are collectively know as nutritive sweeteners as they not only provide sweetness but are also absorbable into the bloodstream by humans and can be metabolized, providing energy for immediate use or for storage as fat.

Many nutritive sweeteners that can be used by consumers to flavor their foods are known to those skilled in the art. These include sucrose (table sugar), crystalline glucose and fructose, trehelose and the like. Consumers can also add sweetness with syrups, such as, corn syrups, molasses, and the like.

High intensity sweeteners are well known alternatives to nutritive sweeteners. They provide sweetness without the calories and other metabolic impacts of the nutritive alternatives. In many cases they provide a sweet flavor that is preferred by many consumers to their nutritive alternatives. In some cases they are blended with nutritive sweeteners. Some high intensity sweeteners are technically nutritive, as they are absorbed and metabolized for energy. Aspartame is an example of a sweetener in this class. However, as high intensity sweeteners are used in small quantities to provide a normal amount of sweetness, they contribute a negligible amount of energy to the user.

Standard nutritive and low-calorie sweeteners, including high intensity sweeteners, are available in many forms, such as, small packets or sachets, generally holding 1 or 2 teaspoon equivalents of sucrose sweetness. Granular formulations are typically designed to provide sweetness on a spoon-for-spoon basis with sucrose. Tablets, each generally contains 1 or 2 teaspoon equivalents of sucrose sweetness. Liquid drops, each of which is calibrated to deliver sweetness is calibrated to one or more teaspoons of sucrose sweetness. Other forms include sucrose teaspoon equivalent cubes bulked to provide a reasonable size with and inert or low calorie bulking material, sprays, impregnated sticks, and various other forms. Others are known to those skilled in the art.

Each current delivery form suffers from some shortfall. For example, packets provide a pre-measured volume of material to deliver 1 or 2 teaspoons sweetness equivalents of sucrose per packet. While packets allow users to tailor the sweetness level in the product that the contents of the packet is being added to by using less than the entire contents of the packet or by using several packets, packets have several disadvantages. In particular, small amounts of high intensity sweetener is actually needed to provide the equivalence of 1 or 2 teaspoons of sucrose. For example, 1 teaspoon of sucrose can be replaced with just 0.0066 grams of sucralose. This small amount is typically overcome by diluting the high intensity sweetener with a bulking material, which increases the volume of the material by about 50 to about 100 times. This bulk results in a second problem, the addition of unwanted material, usually a carbohydrate, to the sweetened product. Waste created by the packets themselves and the unused sweetener from custom dosing is also an issue as is the difficulty in repeating a “custom dose”.

Granular forms allow variable dosing, but require a transfer device, such as, a spoon, for measuring and delivering the sweetener to the item to be sweetened. Such forms of high intensity sweeteners also require a bulking material to give the granular form volumetric or weight based equivalence to sucrose. As with the packets, the bulking agent is not always needed in the sweetened product.

Tablets are portable, but make custom sweetness level attainment difficult. The same can be said for cubes.

Liquid sprays provide even distribution but require a spraying device to use.

Users have a wide variety of preferences for the level of sweetness for various products they taste. For example, a quick observation of coffee drinkers will show that some add anywhere from a partial packet to 3 or more packets to a cup of coffee. Given this, and the currently available solutions, two basic scenarios exist, both of which are disadvantageous: Consumers can use sweeteners that come in unit doses, such as packets, cubes, tablets, and dispose of the excess material. Or, consumers can carry bulked-sweeteners, such as a granular material, and a spoon or a spraying device to deliver the desired quantity of bulked sweetener. To allow measuring of the sweetness delivered added bulking material and the weight or calories therein is required.

Herein a new delivery system, which overcomes many of the previous problems is disclosed.

### SUMMARY OF THE INVENTION

An embodiment of the present invention is a solid sweetening crystal comprising, consisting of, and/or consisting essentially of a nutritive sweetener in intimate contact with a high intensity sweetener, wherein the crystal comprises, consists of, and/or consists essentially of a matrix and a surface and crystal comprises, consists of, and/or consists essentially of an SSD of from about 0.01 g SES per g to about 300 g SES/g and an energy content of less than about 2 kcal/gram of SES.

A further embodiment of the present invention is a solid, sweetening composition comprising, consisting of, and/or consisting essentially of a first material selected from the group consisting of a sugar, a sugar polymer, a sugar alcohol and combinations thereof in intimate contact with a second material crystal comprising, consisting of, and/or consisting essentially of at least one high intensity sweetener, wherein the first material comprising a crystalline matrix, the solid, sweetening composition has a SES from about 2 to about 300, and the solid, sweetening composition has less than 0.25 kcal/gram of SES.

An additional embodiment of the present invention is a solid, sweetening composition comprising, consisting of, and/or consisting essentially of a first material selected from the group consisting of a sugar, a sugar polymer, a sugar alcohol and combinations thereof that is intimate contact with a second material comprising, consisting of, and/or consisting essentially of at least one high intensity sweetener, wherein: the first material comprising, consisting of, and/or consisting essentially of a crystalline matrix that includes the second material, the SSD for the composition is between than 2 grams SES per gram and 300 SES per gram, and the energy content of the composition is less than 0.25 kcal/gram of SES.

A still further embodiment of the present invention is a sweetening kit comprising, consisting of, and/or consisting essentially of a solid sweetening crystal comprising, consisting of, and/or consisting essentially of a nutritive sweetener in intimate contact with a high intensity sweetener, wherein the crystal comprises, consists of, and/or consists essentially of a matrix and a surface and comprises, consists of, and/or consists essentially of an SSD of from about 0.01 g SES per g to about 300 g SES/g and an energy content of less than about 2 kcal/gram of SES and a container for holding the solid sweetening crystal.

Another embodiment of the present invention is a solid, sweetening composition comprising, consisting of, and/or consisting essentially of a first material selected from the group consisting of a sugar, a sugar polymer, a sugar alcohol and combinations thereof that is intimate contact with a second material comprising, consisting of, and/or consisting essentially of at least one high intensity sweetener, wherein the first material comprising, consisting of, and/or consisting essentially of a crystalline matrix, the solid, sweetening composition crystal comprises, consists of, and/or consists essentially of a SSD of from about 2 grams SES per gram to about 300 grams SES per gram, and the energy content of the solid, sweetening composition is less than about 2 kcal/gram of SES.

### DETAILED DESCRIPTION OF THE INVENTION

As used herein, the term “SES” means the amount of sweetness provided by a unit of the sweetener divided by amount of sweetness provided by the same unit amount of sucrose. For example, 1 gram of sucralose provides the sweetness of from about 500 to about 600 grams of sucrose, depending on the application. So, sucralose would have a SES of from about 500 to about 600. For this disclosure, a 5% sucrose solution in water is the standard application used for calibration of SES.

As used herein, a recitation of a range of values herein is merely intended to serve as a shorthand method of referring individually to each separate value falling within the range, and each separate value is incorporated into the specification as if it were individually and explicitly recited.

As used herein, the term “SSD” or “sweetness densities” means grams of SES/per gram of solid.

As used herein, the term “high intensity sweetener” means a sweetener that provides at least about 2 g of sucrose equivalent sweetness per gram sweetener. Preferably, a high intensity sweetener provides about 40 g of sucrose equivalent sweetness per gram and more preferably about 200 g of sucrose equivalent sweetness per gram. One gram of certain high intensity sweeteners, e.g., neotame, can provide the sweetness of about 8,000 g sucrose. Many high intensity sweeteners are known to those skilled in the art. Among those in widespread use include aspartame, acesulfame, saccharine, cyclamate, neotame, sucralose, brazien and other protein based sweeteners, plant extracts, such as, stevia and luo hon guo, and the various salts, derivatives, and combinations or mixtures thereof.

As used herein, the term “low calorie sweetener” means a sweetener that provides from about 0 to about 3 kcals per gram of sucrose equivalent sweetness. In addition to polyhydric alcohols, other low calorie sweeteners are available. These include tagatose, and stereoisomer of grain sweeteners such as 1-glucose.

As used herein, the term “co-crystallized” means crystallized, precipitated, or dried from common mother liquor, where the resultant solid has some crystalline feature.

Polyhydric alcohols, i.e., sugar alcohols, typically have lower caloric content than sucrose, but are still considered nutritive sweeteners. These compounds are often used as a low-calorie replacement for sucrose. They include sorbitol, xylitol, mannitol, erythritol, isomalt, ,lactitol, malitol, and hydrogenated starch hydrolysates. This class of sweeteners is not high-intensity sweeteners, and is nutritive as they do provide energy to the body, but they typically provide less energy both per gram and per unit of sweetness delivered than other nutritive sugars such as sucrose.

We have found that crystallizable nutritive sweeteners that have a molecular weight of less than about 1,000 (“low molecular weight sugar”) can be co-crystallized with at least one high-intensity sweetener at surprisingly high levels of the high-intensity sweetener(s). Further, we have found that these compositions have SSD over twice those previously known and over thirty times those previously seen in a crystal matrix. The crystals of the present invention have a uniform sweetness per gram, and a translucent appearance, which refracts light in a gem like fashion. The crystals of the present invention provide a convenient way to deliver a sweetener to a beverage or food preparation. A person can select a crystal, or crystals, to provide the desired sweetness level.

One aspect of the invention is the crystal can be selected by hand. This is facilitated by maintaining the sweetness density, i.e., SSD, in a range where a standard unit of sweetness, for example, 1 teaspoon SES, and be picked up by hand and placed in a beverage or food. Likewise, the SSDs are high enough such that a small container, for example a containing measuring about 1.5 inches by about 2.5 inches, by about 0.5 inch deep, can hold the equivalent of about one pound of SES. This makes carrying a sweetener feasible and convenient under the present invention.

The composition of the present invention has a SSD that is typically greater than about 2 g of SES per g, greater than about 4 g of SES per g, or even greater than about 8 g of SES per g, and even more preferably greater than about 40 grams of SES per g. The crystals of the present invention have very low energy density, and can be made with sweeteners that do not illicit a blood sugar increase. The energy density of the composition of the present invention is typically less than about 2 kcal/gram SES. The energy density also includes amounts of from about 0.5 kcals/g SES to about 0.01 kcals/g SES. Also the energy density of the composition of the present invention can be less than about 0.5 kcals/g SES, less than 0.25 kcals/g SES, and even less than 0.05 kcals/g SES. Further the solid crystals of this invention may contain from about 0.1 to about 8 g SES, including from about 0.2 g to 6 g SES and from about 2 to 4 grams of SES.

The crystals form at varying sizes allowing a wide sweetener amount selection. The varying size of crystals is also surprisingly valuable as it lets the user select varying levels of sweetness from a group of crystals based on the application and desired sweetness level. This minimizes or eliminates waste of the sweetening product in selecting the desired amount of sweetness. The particles' solid crystals of this invention have a size to allow them to be selected by hand. This size should be greater than about 0.5mm in one dimension, more preferably from about 1.0 mm to about 10 mm in one dimension, even more preferably between than about 2 mm to about 4 mm in one dimension.

The crystals of the present invention can be made by any process known in the art. For example, in one embodiment, a nutritive sweetener, e.g., sucrose or sugar alcohol, is crystallized and the high-intensity sweetener dissolved into the surface by a spraying step followed by a drying step. While co-crystallization is described, other methods will be apparent to those skilled in the art and are acceptable so long as the SES for the resulting composition is such that the crystalline material is acceptable of hand selection and the energy content of the composition is low on a kcals/gram of SES basis. Other methods include, but are not limited to, co-drying, or precipitation may also be used.

While we have described batch crystallization and drying, continuous processes can also be employed. One embodiment is to add the high-intensity sweetener prior to the final solid isolation for the process that originally manufactured the crystallizable nutritive sweetener. In addition, recycling of fines, co-drying, co-precipication and manufacture at end of nutritive sweetener producing process can be used.

Additives, such as, color, flavor, aroma, and nutrients can also be applied to crystals of the present invention. For example, a flavor or aroma can be added to the solution of nutritive sweetener and high intensity sweetener prior to crystallization. Alternatively, these could be added to the surface of the crystals after formation but before drying or after drying

Another alternative would agglomerate a flavor component to the sweetening composition disclosed herein.

Nutrients, for example, soy isoflavones may be added to crystals for use by post-menopausal women for use in controlling hot flashes. Alternatively, vitamin D could be added for promote strong bones.

Color can also be added to the crystal by adding a colorant to the solution of nutritive sweetener and high intensity sweetener prior to crystallization. Alternatively, these could be added to the surface of the crystals after formation but before drying or after drying. Color can provide additional interest to the consumer or provide a means to identify crystals with different flavors added.

The color used in the present invention can be used to identify additives added to the crystal of the present invention. For example, if lemon flavor is added, yellow color can be added as a flavor designator.

The composition of the present invention can be packaged individually or in small boxes contain 2 or more crystals. They can also be packed so that the package contains a standard unit of SES, e.g., a teaspoon, a gram, a cup, a pound, a kilogram, or a liter. The crystals can be packed in containers so packaging waste is minimized.

### EXAMPLES

### Example 1

### Co-Crystallization of Erythritol and Sucralose

201.4 grams of tap water (New Brunswick, N.J., public water supply) was placed in a 500 ml beaker and heated to a slow boil. 219 grams of erythritol (Cargill Inc, Minn. Minn.) and 10.6 grams of sucralose (McNeil Nutritionals, LLC) were added to the solution. The solution was maintained at a slow boil and stirred until the materials dissolved. The solution was then removed from the heat and allowed to cool. When the beaker was cooled to the point at which it could be touched, a few additional erythritol crystals are added and the solution was allowed to sit quiescently. In about 1 hour, a significant crop of crystals emerged. The solution was then allowed to sit for another 3 hours at which time the crystals were separated from the remaining mother liquor, placed on a plate, broken by hand into smaller units to remove some of the agglomeration, and then allowed to air dry at room temperature overnight.

The resulting crystals were translucent white, and ranged in dimension from about 1 mm to about 11 mm. They had an average weight of about 0.03 grams, with a high weight of about 0.11 grams, and a low weight of about 0.01 grams. Some crystal dust was present.

### Example 2

### Use of Co-Crystallized of Erythritol and Sucralose

A panel of three individuals tested the crystals from Example 1 as follows. First, each prepared a beverage normally used by them using the FLAVIA® brand beverage system. The panelists then added crystals from Example 1 to the beverage, stirring between additions, until the beverage was sweetened to taste. All reported pleasant sweetness.

| Panelist | Sex | Beverage |
|---|---|---|
| 1 | M | Flavia Herb Red |
| 2 | F | Columbian |
| 3 | M | Capachino |

### Example 3

### Co-Crystallization of Erythritol and Sucralose

230 grams of tap water (New Brunswick, N.J., Public Water supply), was placed in a 500 ml beaker and heated to a slow boil. 186 grams of erythritol (Cargill Inc, Minn. Minn.) and 60 grams of sucralose (McNeil Nutritionals, LLC) were added to the solution. The solution was maintained at a slow boil and stirred until the materials dissolved. The solution was then removed from the heat and allowed to cool. When the beaker was cooled to the point at which it could be touched, a few additional erythritol crystals were added and the solution was allowed to sit quiescently. In about 1 hour a significant crop of crystals emerged. The solution was allowed to sit for another 3 hours at which time the crystals were separated from the remaining mother liquor, placed on a plate, broken by hand into smaller units to remove some the agglomeration, and then allowed to air dry over night.

A single crystal was added to a cup of Herb Red Tea (FLAVIA® brand) and consumed. A pleasant sweet taste was reported

### Example 4

### Co-Crystallization of Trehelose and Sucralose

Trehelose (Cargill, Inc, Minneapolis, Minn.) was substituted for erythritol in Example 1, and crystallized as described. Crystallization was allowed to continue overnight prior to air drying.

The crystals were translucent white. A single crystal was added to a cup of FLAVIA® brand Breakfast Blend Coffee, brewed on a FLAVIA® brand Machine. The user reported a clean pleasant sweet taste.

During the drying of the crystals some crystal dust was created.

### Example 5

### Addition of Vanilla Flavor to Crystals

10 grams of trehelose/sucralose crystals from Example 4 were added to a 200 ml beaker. 4 drops of vanilla extract in alcohol (McCormick) were added to the beakers and the contents stirred to allow the vanilla extracts to coat the crystals. A single-coated crystal was added to a cup or FLAVIA® brand Breakfast Blend Coffee, prepared on a FLAVIA® brand machine. The user noted a clean sweet taste with a slight vanilla note.

### Example 6

### Addition of Color to Crystals

241.12 g isomalt and 50.76g water were blended in a glass container. The container was heated to a boil and 103.52 g maltisweet syrup (SPI type 3145) was added. The solution was heated to 290° F. and then cooled to 220° F. at which time 3.42 g of sucralose was added. Color, flavor, and citric acid (50% solution) were weighed into individual containers.
1. Blue Color (0.005%-0.05%)
2. Flavor (0.05%-1.2%)
3. Citric acid 50% solution (0.25% in all but vanilla)

Into each container, 20 g of the isomalt/maltisweet, sucralose solution was added and, stirred until completely dissolved. The mixtures were allowed to cool and stored in a dry environment until solid and then broken into small pieces using sharp object. The crystals were placed into a hot cup of water where the colored crystal dissolved yielding a sweet blue translucent liquid.

TABLE 1

| | | | | | | Maltisweet | | | |
|---|---|---|---|---|---|---|---|---|---|
| | | | | Sweetener | Erythritol | syrup | Isomalt | Trehelose | sucralose |
| | | | | kcal/g | 0.1 | 3 | 1 | 4 | 0 |
| | | | | g SES/g | 0.7 g | 0.7 | 0.5 | 0.5 g | 500 g |
| | Non- | | HIS: | | | | | | |
| | erythritol: | | Nutritive | kcals/g | | | | | |
| Example | erythritol | g SES/g | Sweetener | SES | | | | | |
| 1 | 0.05 | 33.93 | 4.840% | 0.004 | 219 | | | | 10.6 |
| 3 | 0.32 | 174.97 | 32.258% | 0.001 | 186 | | | | 60 |
| 4 | 0.05 | 34.69 | 5.000% | 0.157 | | | | 100 | 5 |
| 6 | | 8.76 | 1.131% | 0.225 | | 60.0416 | 242.12 | | 3.42 |

Table 1 contains the calculated specific caloric densities (kcals/gram SES), and SSDs for each of the examples.

Although the invention is illustrated and described above with reference to specific embodiments, the invention is not intended to be limited to the details shown. Rather, various modifications may be made in the details within the scope and range of equivalents of the claims and without departing from the invention. Recitation of ranges of values herein are merely intended to serve as a shorthand method of referring individually to each separate value falling within the range, unless otherwise indicated herein, and each separate value is incorporated into the specification as if it were individually recited herein.

What is claimed is:

1. A solid sweetening crystal comprising a nutritive sweetener in intimate contact with a high intensity sweetener, wherein the crystal comprises a matrix and a surface and contains an SSD of from about 0.01 g SES per g to about 300 g SES/g and an energy content of less than about 1 kcal/gram of SES.

2. A solid sweetening crystal of claim 1, wherein the high intensity sweetener is selected from the group consisting of sucralose, aspartame, neotame, saccharine, acesulfame, cyclamate, alitame, a protein sweetener, a natural plant extract and mixtures thereof.

3. A solid sweetening crystal of claim 2, wherein the high intensity sweetener is sucralose.

4. A solid sweetening crystal of claim 1, wherein the nutritive sweetener is selected from the group consisting of erythritol, trehelose, isomalt, maltisweet, sucrose, fructose, dextrose, tagatose and combinations thereof.

5. A solid sweetening crystal of claim 1, wherein the nutritive sweetener contains less than about 4 kcals per gram.

6. A solid sweetening crystal of claim 1, wherein the nutritive sweetener is erythritol or trehelose.

7. A solid sweetening crystal of claim 1, wherein one dimension of the solid sweetening crystal is greater than about 0.5 mm.

8. A solid sweetening crystal of claim 1, wherein the solid sweetening crystal contains from about 2 to about 100 g SES/g.

9. A solid sweetening crystal of claim 1, further comprising an ingredient selected from the group consisting of a comestible color, a nutrient, a flavor, an aroma and combinations thereof.

10. A solid sweetening crystal of claim 9, wherein the ingredient is provided in the crystal matrix or on the surface of the solid sweetening crystal.

11. A solid sweetening crystal of claim 1, wherein the crystal contain from 0.1 to 8 grams of SES.

12. A solid sweetening crystal of claim 1, wherein the natural plant extract is stevia, luo han guo, or combinations thereof.

12. A solid, sweetening composition comprising a first material selected from the group consisting of a sugar, a sugar polymer, a sugar alcohol and combinations thereof in intimate contact with a second material comprising at least one high intensity sweetener, wherein:
i) the first material comprising a crystalline matrix,
ii) the solid, sweetening composition has a SES from about 2 to about 300, and
iii) the solid, sweetening composition has less than 0.25 kcal/gram of SES.

13. A solid, sweetening composition comprising a first material selected from the group consisting of a sugar, a sugar polymer, a sugar alcohol and combinations thereof that is intimate contact with a second material comprising at least one high intensity sweetener, wherein:
i) the first material comprising a crystalline matrix that includes the second material,
ii) the SSD for the composition is between than 2 grams SES per gram and 300 SES per gram, and
iii) the energy content of the composition is less than 0.25 kcal/gram of SES.

14. A sweetening kit comprising
a) a solid sweetening crystal comprising a nutritive sweetener in intimate contact with a high intensity sweetener, wherein the crystal comprises a matrix and a surface and contains an SSD of from about 0.01 g SES per g to about 300 g SES/g and an energy content of less than about 1 kcal/gram of SES and
b) a container for holding the solid sweetening crystal.

15. A solid sweetening crystal of claim 1, wherein the crystal contains from 0.1 to 8 grams of SES.

16. A solid, sweetening composition comprising a first material selected from the group consisting of a sugar, a sugar polymer, a sugar alcohol and combinations thereof that is intimate contact with a second material comprising at least one high intensity sweetener, wherein:
a) the first material comprising a crystalline matrix,
b) the solid, sweetening composition has a SSD of from about 2 grams SES per gram to about 300 grams SES per gram, and
c) the energy content of the solid, sweetening composition is less than about 1 kcal/gram of SES.
